(19) United States
(12) Patent Application Publication
(10) Pub. No.: US 2008/0110305 A1
(43) Pub. Date: May 15, 2008

(54) Hexagonal spanner

(76) Inventor: Cheng-Chien Tsai, Taichung (TW)

Correspondence Address: Cheng-Chien Tsai, 235 Chung-Ho, Box 8-24, Taipei, omitted

(21) Appl. No.: 11/599,557

(22) Filed: Nov. 15, 2006

(51) Int. Cl. B25B 23/02; B25B 23/00

(52) U.S. Cl. 81/451; 81/459

(57) ABSTRACT

A hexagonal spanner having an L shape comprises a short driving portion having a groove at one distal end thereof; and a first tightening unit enclosing around the groove of the short driving portion; an outer diameter of the first tightening unit being greater than a maximum diameter of the short driving portion; and a long driving portion having a groove at one distal end thereof; and a second tightening unit enclosing around the groove; an outer diameter of the second tightening unit being greater than a maximum diameter of the long driving portion.

### FIELD OF THE INVENTION

The present invention relates to hexagonal spanners, and particularly to a hexagonal spanner, wherein the driving portion can be tightly adhered to a groove of a screw unit so that the operation is easy and convenient.

### BACKGROUND OF THE INVENTION

The prior art hexagonal spanner has an L shape with a bending portion at a middle section thereof. Two ends of the hexagonal spanner are driving portions. A periphery of each driving portion has a hexagonal shape. The driving portion can be inserted into a groove of a screw unit. The user can drive another end of the hexagonal spanner not being inserted into the groove so as to drive the screw unit to enter into or separate from an object. In general, the size of the driving portion is slightly smaller than that of the groove so that the driving portion can be easily inserted into the groove, however the outer surface of the driving portion is not completely adhered to an inner surface of the threaded groove. Thus in operation, the hand of the user must hold the screw unit for screwing.

In one improvement for improving the above mentioned defect in operation, the driving portion has a radial slit and an axial screw hole. The screw hole has a tapered hole section which is matched to a head of the screw unit. The screw unit will enforce the tapered hole section to deform so that the driving portion is enlarged. An outer periphery of the driving portion will resist against the inner hexagonal screw unit.

However in above mentioned improved design, the slit will deform due to the screw unit and the structure of the driving portion is weakened. If a great torque is applied to the screw unit, it is possible that the driving portion will be destroyed. Moreover, to make the driving portion to tightly adhere to the groove, a screw opener is used to adjust the screw unit for matching the various sizes of the screw units. Thereby the use is inconvenient.

Moreover, to use a screw opening to adjust the engagement of the driving portion and screw unit will make the manufacturing process being complicated and thus the cost is increased. Moreover, in the operation of loosing the screw unit, it is possible that the driving portion falls out from the groove, even the spanner is lost.

### SUMMARY OF THE INVENTION

Accordingly, the primary object of the present invention is to provide a hexagonal spanner, wherein the driving portion can be tightly adhered to a threaded groove of a screw unit so that the operation is easy and convenient.

To achieve above objects, the present invention provides a hexagonal spanner having an L shape which comprises a short driving portion having a groove at one distal end thereof; and a first tightening unit enclosing around the groove of the short driving portion; an outer diameter of the first tightening unit being greater than a maximum diameter of the short driving portion; a long driving portion having a threaded groove at one distal end thereof; and a second tightening unit enclosing around the groove; an outer diameter of the second tightening unit being greater than a maximum diameter of the long driving portion. The tightening unit may be a C ring or an O ring.

The various objects and advantages of the present invention will be more readily understood from the following detailed description when read in conjunction with the appended drawing.

### BRIEF DESCRIPTION OF THE DRAWINGS

FIG. 1 is an exploded perspective view of the hexagonal spanner of the present invention.

FIG. 2 is a schematic cross sectional view of the hexagonal spanner of the present invention.

FIG. 3 is a partial enlarged view of the structure illustrated in FIG. 2.

FIG. 4 is a schematic perspective view of the second embodiment of the present invention, where two ends of the head end have threaded grooves.

FIGS. 5 and 6 are schematic views showing the application of the present invention.

FIG. 7 is a schematic cross sectional view showing that the tightening unit of the present invention is an O ring.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

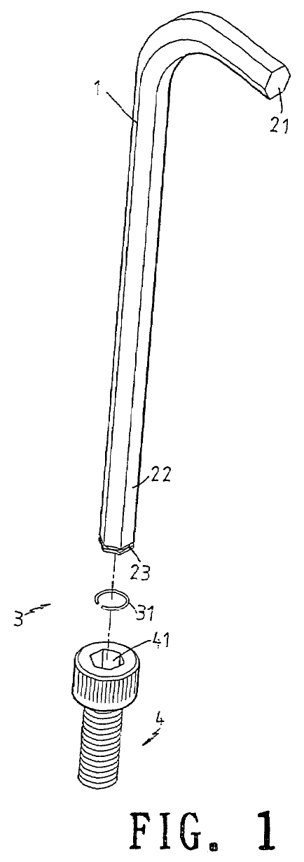

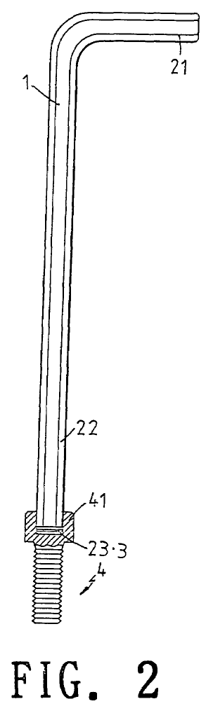

Referring to FIGS. 1 and 2, the interior hexagonal spanner of the present invention is illustrated. The present invention has the following elements.

A body 1 has an L shape including a long driving portion 22 and a short driving portion 21. One distal end of the long driving portion 22 is formed with an embedding groove 23. A tightening unit 3 encloses the tightening unit 3. The tightening unit 3 is for example a C ring 31 illustrated in FIG. 1. An outer diameter of the tightening unit 3 is greater an outer diameter of the long driving portion 22. In use, the long driving portion 22 is placed into a groove 41 of an interior hexagonal screwing unit 4. By driving the short driving portion 21, the long driving portion 22 is tightly engaged to the groove 41 of the interior hexagonal screwing unit 4.

The tightening unit 3 is placed into the embedding groove 23 to tightly adhere thereon. The tightening unit 3 is elastic and in this embodiment, the tightening unit 3 is a C ring 31 made of metal material. Since the C ring 31 is elastic, it can easily engaged to the embedding groove 23.

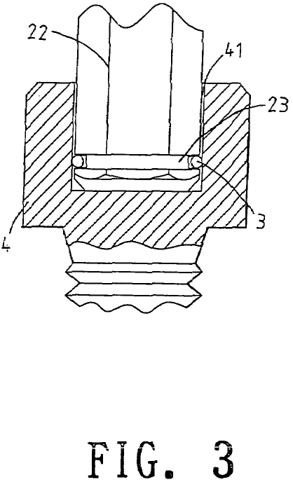

Referring to FIG. 3, if it is desired to make the long driving portion 22 to be placed into the groove 41, the diameters of the long driving portion 22 and short driving portion 21 are slightly smaller than those of the groove 41. When the long driving portion 22 having the tightening unit 3 is placed into the groove 41 of the interior hexagonal screwing unit 4. The C ring 31 will tightly engage an inner wall of the groove 41. When it is desired to release the long driving portion 22 from the groove 41, it is only necessary to apply a slight force to the body 1 and the C ring 31 will deform so that the long driving portion 22 can be pulled out from the groove 41 easily.

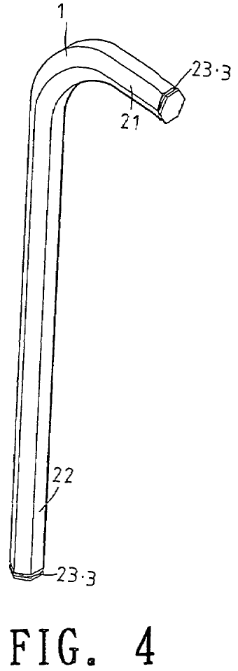

Referring to FIG. 4, in the present invention, the short driving portion 21 can also have an embedding groove 23 and another tightening unit 3 encloses the groove 41 of the short driving portion 21.

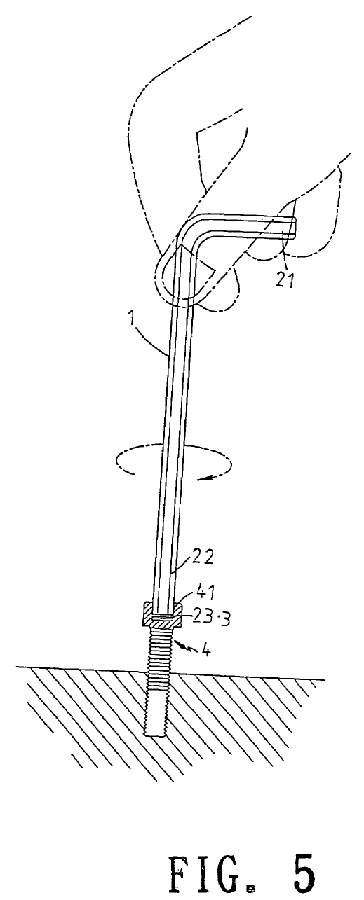

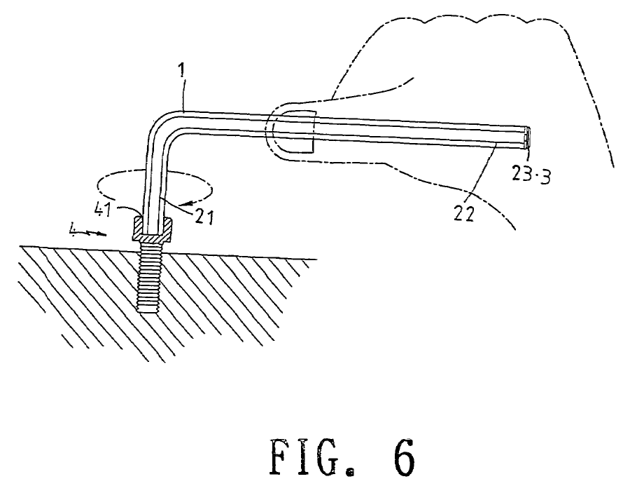

Referring to FIGS. 5 and 6, in use, the long driving portion 22 is easy to be inserted into the groove 41. In the initial stage, the long driving portion 22 is inserted into the groove 41 for driving the interior hexagonal screwing unit 4. This is because the long driving portion 22 can be aligned to the groove 41 easily. For a while, the long driving portion 22 is withdrawn from the groove 41 and then the short driving portion 21 is inserted into the groove 41 from the following operation. This is because the long driving portion 22 can provides a great arm of force. Thus, if the short driving portion 21 is inserted into the groove 41, the long driving portion 22 can provide a great arm of force.

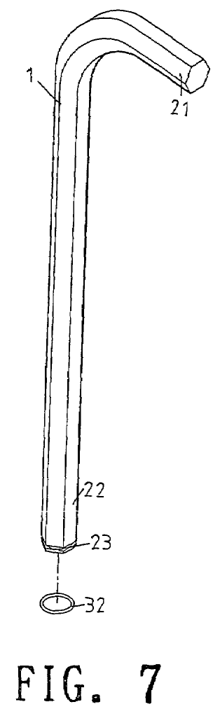

In the present invention, the C ring 31 may be replaced by other material instead of metal. Moreover, referring to FIG. 7, it is illustrated that the C ring 31 can be replaced by an O ring 32 made of flexible material, such as rubber. An outer diameter of the O ring 32 is greater than a diameter of the long driving portion 22 so that it can tightly enclose the tightening unit 3.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A hexagonal spanner having an L shape comprising:
a hexagonal short driving portion;
a hexagonal long driving portion having a groove at one distal end thereof; and
a C ring enclosing around the groove; an outer diameter of the C ring being greater than a maximum diameter of the long driving portion.

2. The hexagonal spanner as claimed in claim 1, wherein the short driving portion having a groove; and a C ring encloses around the groove; an outer diameter of the C ring is greater than a maximum diameter of the long driving portion.

3-5. (canceled)

6. A hexagonal spanner having an L shape comprising:
a hexagonal short driving portion;
a hexagonal long driving portion having a groove at one distal end thereof; and
an O ring enclosing around the groove; an outer diameter of the O ring being greater than a maximum diameter of the long driving portion.

7. The hexagonal spanner as claimed in claim 6, wherein the short driving portion having a groove; and a C ring encloses around the groove; an outer diameter of the C ring is greater than a maximum diameter of the long driving portion.
